(19) United States
(12) Patent Application Publication
(10) Pub. No.: US 2026/0228856 A1
(43) Pub. Date: Aug. 6, 2026

(54) ENHANCING VISION MODELS WITH A LEARNED UPSAMPLING ROUTINE

(71) Applicant: NVIDIA CORPORATION, Santa Clara, CA (US)

(72) Inventors: Michael RANZINGER, Park City, UT (US); Pavlo MOLCHANOV, Mountain View, CA (US); Gregory HEINRICH, Nice (FR)

(21) Appl. No.: 19/370,471

(22) Filed: Oct. 27, 2025

Related U.S. Application Data
(60) Provisional application No. 63/753,358, filed on Feb. 3, 2025.

(51) Int. Cl. G06T 3/4053; G06N 3/045; G06T 5/70

(52) U.S. Cl. CPC G06T 3/4053; G06N 3/045; G06T 5/70; G06T 2207/20084

(57) ABSTRACT

At least one embodiment for enhancing vision models with a learned upsampling routine includes receiving a 2D image, processing the 2D image to generate a feature map and a tiled feature map, generating a de-biased feature map and a de-biased tiled feature map by removing artifacts from the feature map and the tiled feature map, generating an upsampled feature map from the de-biased feature map, generating a concatenated feature map from the upsampled feature map and the de-biased tiled feature map, processing the concatenated feature map to generate an output feature map, and generating an enhanced feature map by slicing off one or more channels of the output feature map.

### CROSS-REFERENCE TO RELATED APPLICATIONS

This application claims priority benefit of the United States Provisional Patent Application titled, “TECHNIQUES FOR ENHANCING VISION MODELS WITH A LEARNED UPSAMPLING ROUTINE,” filed on Feb. 3, 2025, and having Ser. No. 63/753,358. The subject matter of this related application is hereby incorporated herein by reference.

### BACKGROUND OF THE INVENTION

### Field of the Invention

Embodiments of the present disclosure relate generally to computer vision, machine learning, and artificial intelligence and, more specifically, to enhancing vision models with a learned upsampling routine.

### Description of the Related Art

A vision foundation model (VFM) is a machine learning model trained on large scale data that can be fine-tuned to a wide variety of downstream tasks, including image classification, object detection, and/or the like. Instead of training several smaller models to perform a specific task, VFMs use a larger base model that only needs to be trained once and can be adapted for multiple applications. VFMs are typically used to perform transfer learning, but VFMs are also used for information retrieval and to power visual capabilities for vision to language models.

One drawback of using VFMs is that VFMs produce low resolution feature maps. Features maps are fundamental to a wide variety of computer vision tasks, including image classification, semantic segmentation, and object detection. VFMs typically use a transformer-based machine learning model as the larger base model. Transformers are computationally demanding and expensive to use at high-resolution. In particular, the computational cost of using a vision transformer to generate a higher resolution feature map increases quadratically with the number of input tokens. These increasing computational costs result in low-resolution features maps. For example, CLIP, a VFM that learns visual concepts from natural language supervision, runs at 224 or 336 pixel input resolution and produces spatial features at a 14x downsample. Using low resolution features limits the VFMs effectiveness at performing downstream prediction tasks such as segmentation or depth estimation.

To improve the resolution feature maps, VFMs often employ upsampling techniques. Traditional upsampling techniques use bilinear or nearest neighbor interpolation to increase the resolution of feature maps. One drawback of these techniques, however, is that these techniques fail to capture small objects and fine-grained details of the input image. In addition, traditional upsampling techniques may introduce blurring artifacts which can be directly visible in the VFM output features.

As the foregoing illustrates, what is needed in the art are more effective techniques for upsampling feature maps.

### SUMMARY

According to some embodiments, a computer-implemented method for generating an enhanced feature map. The method includes receiving a two-dimensional (2D) image, processing the 2D image to generate a feature map and a tiled feature map, generating a de-biased feature map and a de-biased tiled feature map by removing artifacts from the feature map and the tiled feature map, generating an upsampled feature map from the de-biased feature map, generating a concatenated feature map from the upsampled feature map and the de-biased tiled feature map, processing the concatenated feature map to generate an output feature map, and generating an enhanced feature map by slicing off one or more channels of the output feature map.

Further embodiments provide, among other things, non-transitory computer-readable storage media storing instructions and systems configured to implement the method set forth above.

At least one technical advantage of the disclosed techniques relative to the prior art is that, with the disclosed techniques, higher resolution feature maps of 2D images are produced. The disclosed techniques generate feature maps that more accurately capture small objects and fine-grained details of the input image than prior art approaches, thereby increasing the usefulness of feature maps in downstream prediction tasks. In addition, the disclosed techniques remove artifacts in the feature maps generated by a vision foundation model. Another technical advantage is that the computational cost of generating higher resolution feature maps with the disclosed techniques is less than the computational cost of running a vision foundation model at higher resolution. The computational cost of generating a higher resolution feature map using the disclosed techniques increases linearly with respect to the number of tokens, whereas the computational cost of generating a higher resolution feature map using a vision transformer increases quadratically. These technical advantages represent one or more technological improvements over prior art approaches.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a computer system configured to implement one or more aspects of the present disclosure;

FIG. 2 is a block diagram of a parallel processing unit included in the parallel processing subsystem of FIG. 1, according to various embodiments;

FIG. 3 is a block diagram of a general processing cluster included in the parallel processing unit of FIG. 2, according to various embodiments;

FIG. 4 is a block diagram of a computer-based system configured to implement one or more aspects of the various embodiments;

FIG. 5 is a more detailed description of the feature enhancing engine of FIG. 4, according to various embodiments;

FIG. 6 is a more detailed description of the feature enhancing module of FIG. 5, according to various embodiments;

FIG. 7 is a flow diagram of method steps for generating enhanced feature maps, according to various embodiments;

FIG. 8 is a flow diagram of method steps for generating feature maps and tiled feature maps, according to various embodiments; and

FIG. 9 is a flow diagram of method steps for using enhanced feature maps, according to various embodiments.

### DETAILED DESCRIPTION

In the following description, numerous specific details are set forth to provide a more thorough understanding of the present invention. However, it will be apparent to one of skill in the art that the present invention may be practiced without one or more of these specific details.

Embodiments of the present disclosure provide techniques for generating a higher resolution feature map of an input image. First, an image is input into a vision foundation model and the vision foundation model outputs a feature map. Next, the same image is divided into tiles. Each tile is resized to match the input resolution of the vision foundation model and input into the vision foundation model independently. The vision foundation model outputs a feature map for each resized tile and the feature maps for each resized tile are then stitched back together to produce a tiled feature map. The feature map and the tiled feature map are de-biased to remove artifacts of the vision foundation model. Then, an upsampling technique is applied to the de-biased feature map to produce an upsampled feature map. The de-biased tiled feature map and the upsampled feature map are then passed through a transformer block with sliding window attention and the transformer block outputs an enhanced feature map of higher resolution than the tiled feature map and the upsampled feature map.

The techniques for generating a higher resolution feature map of an input image have many real-world applications. For example, these techniques can be used in systems where 2D images are segmented or in an object detection system in a hand-held device and/or the like. These techniques also have applications in vehicle navigation systems, as well as medical imaging.

The above examples are not in any way intended to be limiting. As persons skilled in the art will appreciate, as a general matter, the techniques of enhancing vision models with a learned upsampling routine that are described herein can be implemented in any application where higher resolution feature maps of an image is required or useful.

### System Overview

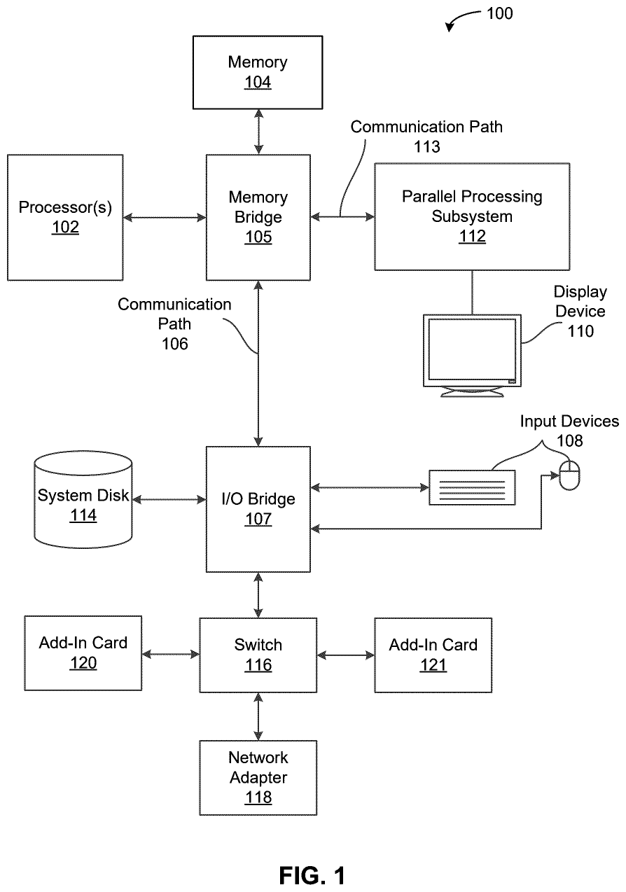

FIG. 1 is a block diagram illustrating a computer system 100 configured to implement one or more aspects of the present embodiments. As persons skilled in the art will appreciate, computer system 100 can be any type of technically feasible computer system, including, without limitation, a server machine, a server platform, a desktop machine, laptop machine, a hand-held/mobile device, or a wearable device. In some embodiments, computer system 100 is a server machine operating in a data center or a cloud computing environment that provides scalable computing resources as a service over a network.

In various embodiments, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as a keyboard or a mouse, and forward the input information to CPU 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via network adapter 130. In one embodiment, switch 116 is configured to provide connections between I/O bridge 107 and other components of computer system 100, such as a network adapter 130 and various add-in cards 120 and 121.

In one embodiment, I/O bridge 107 is coupled to a system disk 114 that may be configured to store content and applications and data for use by CPU 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

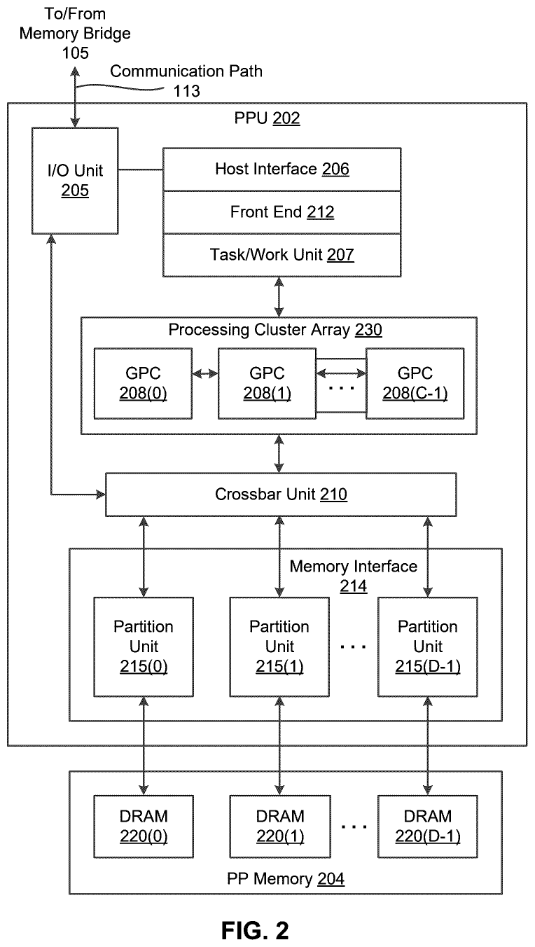

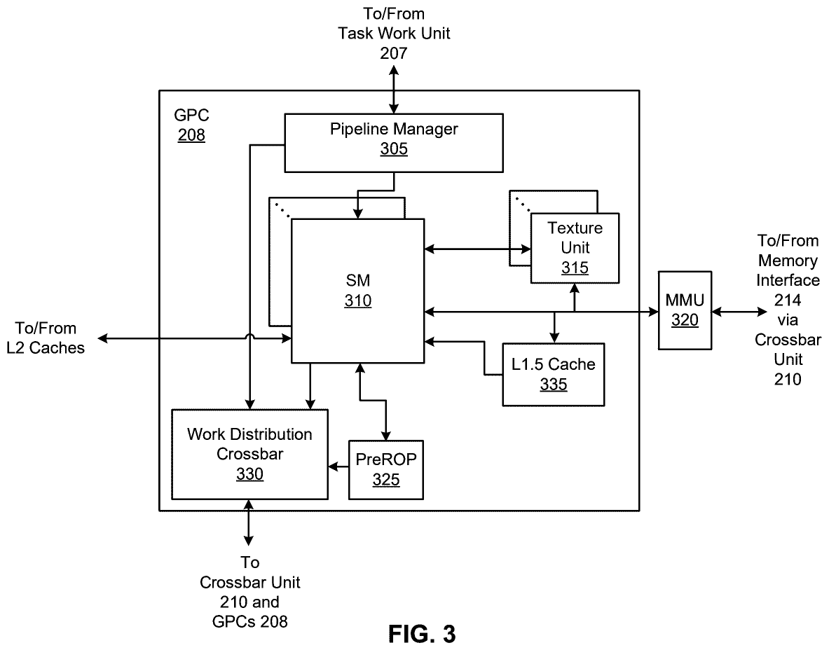

In some embodiments, parallel processing subsystem 112 comprises a graphics subsystem that delivers pixels to an optional display device 110 that may be any conventional cathode ray tube, liquid crystal display, light-emitting diode display, or the like. In such embodiments, parallel processing subsystem 112 incorporates circuitry optimized for graphics and video processing, including, for example, video output circuitry. As described in greater detail below in conjunction with FIGS. 2-3, such circuitry may be incorporated across one or more parallel processing units (PPUs), also referred to herein as parallel processors, included within parallel processing subsystem 112. In other embodiments, parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver configured to manage the processing operations of the one or more PPUs within parallel processing subsystem 112.

In various embodiments, parallel processing subsystem 112 may be integrated with one or more of the other elements of FIG. 1 to form a single system. For example, parallel processing subsystem 112 may be integrated with CPU 102 and other connection circuitry on a single chip to form a system on chip (SoC).

In one embodiment, CPU 102 is the master processor of computer system 100, controlling and coordinating operations of other system components. In one embodiment, CPU 102 issues commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other embodiments, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 could be eliminated, and network adapter 130 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, parallel processing subsystem 112 may be implemented as a virtualized parallel processing subsystem in some embodiments. For example, parallel processing subsystem 112 could be implemented as a virtual graphics processing unit (GPU) that renders graphics on a virtual machine (VM) executing on a server machine whose GPU and other physical resources are shared across multiple VMs.

FIG. 2 is a block diagram of a parallel processing unit (PPU) 202 included in parallel processing subsystem 112 of FIG. 1, according to various embodiments. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a GPU that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to an optional display device 110 for display. In some embodiments, PPU 202 also may be configured for general-purpose processing and compute operations. In some embodiments, computer system 100 may be a server machine in a cloud computing environment. In such embodiments, computer system 100 may not have a display device 110. Instead, computer system 100 may generate equivalent output information by transmitting commands in the form of messages over a network via network adapter 130.

In some embodiments, CPU 102 is the master processor of computer system 100, controlling and coordinating operations of other system components. In one embodiment, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a command queue, also referred to herein as a pushbuffer, to initiate processing of the stream of commands in the data structure. In one embodiment, PPU 202 reads command streams from the command queue and then executes commands asynchronously relative to the operation of CPU 102. In embodiments where multiple pushbuffers are generated, execution priorities may be specified for each pushbuffer by an application program via device driver to control scheduling of the different pushbuffers.

In one embodiment, PPU 202 includes an I/O (input/output) unit 205 that communicates with the rest of computer system 100 via communication path 113 and memory bridge 105. In one embodiment, I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. In one embodiment, host interface 206 reads each command queue and transmits the command stream stored in the command queue to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In one embodiment, front end 212 transmits processing tasks received from host interface 206 to a work distribution unit (not shown) within task/work unit 207. In one embodiment, the work distribution unit receives pointers to processing tasks that are encoded as task metadata (TMD) and stored in memory. The pointers to TMDs are included in a command stream that is stored as a command queue and received by front end unit 212 from host interface 206. Processing tasks that may be encoded as TMDs include indices associated with the data to be processed as well as state parameters and commands that define how the data is to be processed. For example, the state parameters and commands could define the program to be executed on the data. Also, for example, the TMD could specify the number and configuration of the set of CTAs. Generally, each TMD corresponds to one task. The task/work unit 207 receives tasks from front end 212 and ensures that GPCs 208 are configured to a valid state before the processing task specified by each one of the TMDs is initiated. A priority may be specified for each TMD that is used to schedule the execution of the processing task. Processing tasks also may be received from processing cluster array 230. Optionally, the TMD may include a parameter that controls whether the TMD is added to the head or the tail of a list of processing tasks (or to a list of pointers to the processing tasks), thereby providing another level of control over execution priority.

In one embodiment, PPU 202 implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

In one embodiment, memory interface 214 includes a set of D of partition units 215, where D≥1. Each partition unit 215 is coupled to one or more dynamic random access memories (DRAMs) 220 residing within PPM memory 204. In some embodiments, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

In one embodiment, a given GPC 208 may process data to be written to any of the DRAMs 220 within PP memory 204. In one embodiment, crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In some embodiments, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between GPCs 208 and partition units 215.

In one embodiment, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

In one embodiment, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, wearable devices, servers, workstations, game consoles, embedded systems, and the like.

FIG. 3 is a block diagram of a general processing cluster (GPC) 208 included in the parallel processing unit (PPU) 202 of FIG. 2, according to various embodiments. As shown, GPC 208 includes, without limitation, a pipeline manager 305, one or more texture units 315, a preROP unit 325, a work distribution crossbar 330, and an L1.5 cache 335.

In one embodiment, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment, operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In various embodiments, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, 50R), bit-shifting, and computation of various algebraic functions (e.g., planar interpolation and trigonometric, exponential, and logarithmic functions, etc.). Advantageously, the same functional execution unit can be configured to perform different operations.

In one embodiment, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within SM 310, in which case some of the execution may be idle during cycles when that thread group is being processed. A thread group may also include more threads than the number of execution units within SM 310, in which case processing may occur over consecutive clock cycles. Since each SM 310 can support up to G thread groups concurrently, it follows that up to G*M thread groups can be executing in GPC 208 at any given time.

Additionally, in one embodiment, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within SM 310, and m is the number of thread groups simultaneously active within SM 310. In some embodiments, a single SM 310 may simultaneously support multiple CTAs, where such CTAs are at the granularity at which work is distributed to SMs 310.

In one embodiment, each SM 310 contains a level one (L1) cache or uses space in a corresponding L1 cache outside of SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, SMs 310 may beneficially share common instructions and data cached in L1.5 cache 335.

In one embodiment, each GPC 208 may have an associated memory management unit (MMU) 320 that is configured to map virtual addresses into physical addresses. In various embodiments, MMU 320 may reside either within GPC 208 or within memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In one embodiment, in graphics and compute applications, GPC 208 may be configured such that each SM 310 is coupled to a texture unit 315 for performing texture mapping operations, such as determining texture sample positions, reading texture data, and filtering texture data.

In one embodiment, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs.

### Enhanced Feature Maps Generation and Use

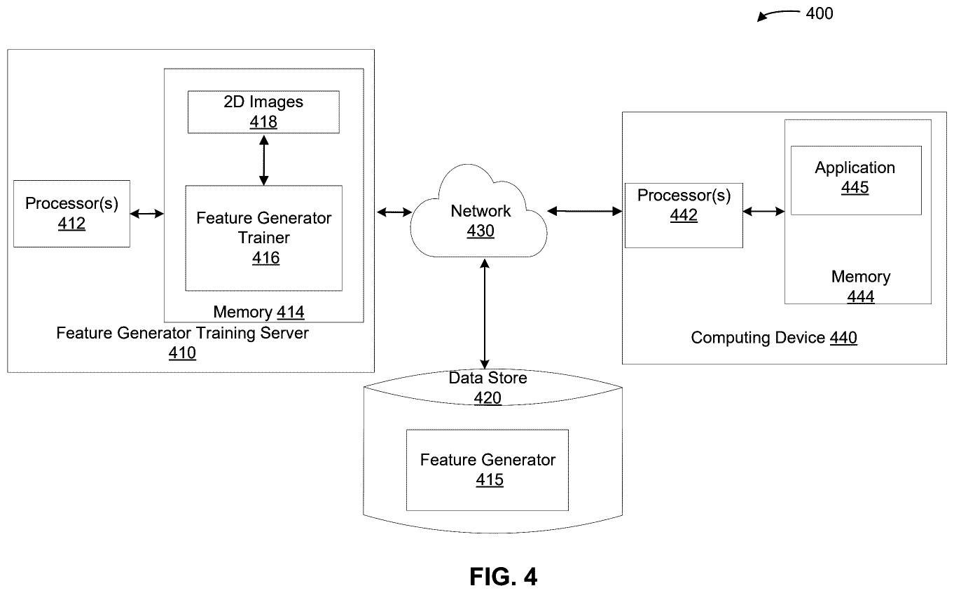

FIG. 4 illustrates a block diagram of a computer-based system 400 configured to implement one or more aspects of the various embodiments. As shown, computer-based system 400 includes, without limitation, a feature generator training server 410, a data store 420, a network 430, and a computing device 440. Feature generator training server 410 includes, without limitation, processor(s) 412 and a memory 414. Memory 414 includes, without limitation, feature generator trainer 416 and 2D images 418. Computing device 440 includes, without limitation, processor(s) 442 and memory 444. Memory 444 includes, without limitation, an application 445. Data store 420 stores, without limitation, feature generator 415. Each of the feature generator training server 410 and the computing device 440 can include similar components, features, and/or functionality as the exemplary computer system 100, described above in conjunction with FIG. 1-3. Each of feature map training server 410 and computing device 440 can be any technically feasible type of computer system, including, without limitation, a server machine or a server platform.

Feature generator training server 410 shown herein is for illustrative purposes only, and variations and modifications are possible without departing from the scope of the present disclosure. For example, the number and types of processor(s) 412, the number of GPUs and/or other processing unit types, the number and types of memories 414, and/or the number of applications included in the memory 414 can be modified as desired. Further, the connection topology between the various units within feature map training server 410 can be modified as desired. In some embodiments, any combination of the processor(s) 412 and the memory 414, and/or GPU(s) can be included in and/or replaced with any type of virtual computing system, distributed computing system, and/or cloud computing environment, such as a public, private, or a hybrid cloud system.

Processor(s) 412 receive user input from input devices, such as a keyboard or a mouse. Processor(s) 412 can be any technically feasible form of processing device configured to process data and execute program code. For example, any of processor(s) 412 could be a central processing unit (CPU), a graphics processing unit (GPU), an application-specific integrated circuit (ASIC), a field-programmable gate array (FPGA), and so forth. In various embodiments any of the operations and/or functions described herein can be performed by processor(s) 412, or any combination of these different processors, such as a CPU working in cooperation with one or more GPUs. In various embodiments, the processor(s) 412 can issue commands that control the operation of one or more GPUs (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

Memory 414 of feature generator training server 410 stores content, such as software applications and data, for use by processor(s) 412. Memory 414 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace memory 414. The storage can include any number and type of external memories that are accessible to processor(s) 412. For example, and without limitation, the storage can include a Secure Digital Card, an external Flash memory, a portable compact disc read-only memory (CD-ROM), an optical storage device, a magnetic storage device, and/or any suitable combination of the foregoing.

2D images 418 are two-dimensional (2D) images that can be obtained by any type of technically feasible video capture device. For example, and without limitation, 2D images 418 can be obtained by a monocular camera such as a smartphone camera or a camera located in a vehicle. Although not shown in FIG. 4, 2D images 418 can be loaded from data store 420 and/or one or more other data repositories.

Feature generator trainer 416 trains feature generator 415 using 2D images 418. In operation, feature generator trainer 416 prepares 2D images 418 by splitting 2D images 418 into a training, testing, and validation datasets. During the training process, feature generator trainer 416 optimizes the parameters of feature generator 415 by minimizing the mean squared error loss on multi-view consistency between upsampled and then downsampled features and different low-resolution views of the same 2D image 418. In various embodiments, feature generator trainer 416 uses a multi-view reconstruction loss term given according to equation (1):

$${ℒ}_{rec} = \frac{1}{\vert T \vert} {\sum }_{t ∈ T} \frac{1}{2 {s}^{2}} {‖ f ( t ( x ) - {σ}_{↓} ( t ( {F}_{hr} ) ) ‖}_{2}^{2} + log ( s ) \qquad ( 1 )$$

where t∈T is a collection of transforms, x is an input image, f the vision foundation model, σ_{↓} a learned downsampler, Fₕᵣ the predicted high-resolution features, and s is a spatially varying adaptive uncertainty. Once trained, feature generator 415 is used by application 445 to generate enhanced feature maps.

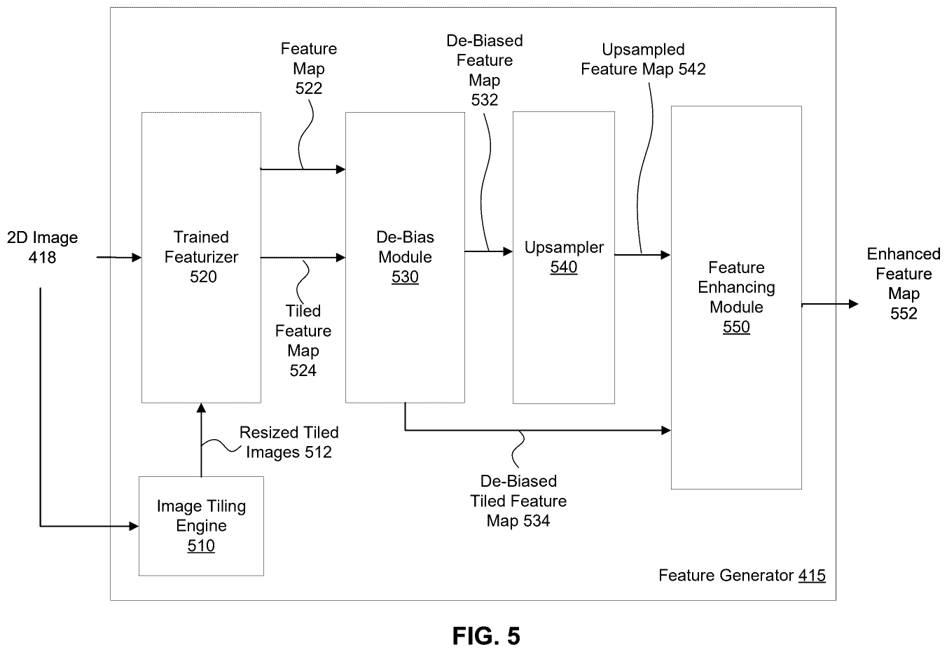

Feature generator 415 is trained by feature generator trainer 416 and is configured to generate enhanced feature maps. First, feature generator 415 inputs a 2D image 418 into a machine learning model and the machine learning model outputs a feature map. In some embodiments, the machine learning model is a vision foundation model. Next, the same 2D image 418 is divided into tiles. Each tile is resized to match the input resolution of the machine learning model and input into the machine learning model independently. The machine learning model outputs a feature map for each resized tile and the feature maps for each resized tile are then stitched back together to produce a tiled feature map. The feature map and the tiled feature map are de-biased to remove data-independent artifacts of the machine learning model. Data-independent artifacts are artifacts produced by the machine learning module independent of the input. Then, an upsampling technique is applied to the de-biased feature map to produce an upsampled feature map. The de-biased tiled feature map and the upsampled feature map are then passed through a transformer and the transformer outputs an enhanced feature map of higher resolution than the feature map output by the machine learning model. The operations performed by feature generator 415 are described in greater detail below in conjunction with FIGS. 5-8.

Data store 420 provides non-volatile storage for applications and data feature generator training server 410 and computing device 440. For example, and without limitation, training data, trained (or deployed) machine learning models and/or application data, 2D images 418, feature generator 415 can be stored in the data store 420 for use by application 445. In some embodiments, data store 420 can include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Data store 420 can be a network attached storage (NAS) and/or a storage area-network (SAN). Although shown as coupled to feature generator training server 410 and computing device 440 via network 430, in various embodiments, feature generator training server 410 or computing device 440 can include data store 420.

Network 430 includes any technically feasible type of communications network that allows data to be exchanged between feature map training server 410, computing device 440, data store 420 and external entities or devices, such as a web server or another networked computing device. For example, network 430 can include a wide area network (WAN), a local area network (LAN), a cellular network, a wireless (WiFi) network, and/or the Internet, among others.

Computing device 440 shown herein is for illustrative purposes only, and variations and modifications are possible without departing from the scope of the present disclosure. For example, the number and types of processor(s) 442, the number and types of memories 444, and/or the number of applications included in the memory 444 can be modified as desired. Further, the connection topology between the various units within computing device 440 can be modified as desired. In some embodiments, any combination of the processor(s) 442 and/or the memory 444 can be included in and/or replaced with any type of virtual computing system, distributed computing system, and/or cloud computing environment, such as a public, private, or a hybrid cloud system. In various embodiments, computing device 440 can be implemented using any of the computing devices of FIGS. 1-3.

Similar to processor(s) 412, processor(s) 442 receive user input from input devices, such as a keyboard or a mouse. Processor(s) 442 can be any technically feasible form of processing device configured to process data and execute program code. For example, any of processor(s) 442 could be a CPU, a GPU, an ASIC, a FPGA, and so forth. In various embodiments any of the operations and/or functions described herein can be performed by processor(s) 442, or any combination of these different processors, such as a CPU working in cooperation with a one or more GPUs. In various embodiments, the one or more GPU(s) perform parallel processing task, such as matrix multiplications and/or the like in LLM model computations. Processor(s) 442 can also receive user input from input devices, such as a keyboard or a mouse and generate output on one or more displays.

Similar to memory 414 of feature generator training server 410, memory 444 of computing device 440 stores content, such as software applications and data, for use by the processor(s) 442. The memory 444 can be any type of memory capable of storing data and software applications, such as a RAM, ROM, EPROM, Flash ROM, or any suitable combination of the foregoing. In some embodiments, a storage (not shown) can supplement or replace the memory 444. The storage can include any number and type of external memories that are accessible to processor(s) 442. For example, and without limitation, the storage can include a Secure Digital Card, an external Flash memory, a portable CD-ROM, an optical storage device, a magnetic storage device, and/or any suitable combination of the foregoing.

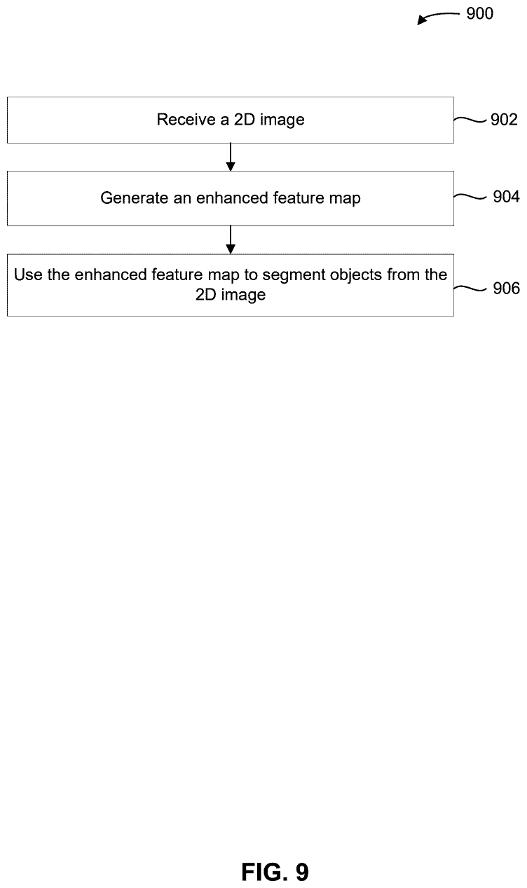

As shown, memory 444 includes application 445. Application 445 can be, without limitation, any type of image segmentation system, or object detection system in an autonomous or manned vehicle and/or a hand-held device. For example, application 445 can receive a 2D image 418 and use feature generator 415 to segment objects from the 2D image. In various embodiments, application 445 can use a camera in an autonomous vehicle and feature generator 415 to identify pedestrians, other vehicles, or annotate an image to displays landmarks or other points of interest. The operations performed by application 445 to use feature generator 415 are described in greater detail in conjunction with FIG. 9.

FIG. 5 is a more detailed illustration of feature generator 415, according to various embodiments. As shown, feature generator 415 includes, without limitation, an image tiling engine 510, a trained featurizer 520, a de-bias module 530, an upsampler 540, and a feature enhancing module 550. Image tiling engine 510 receives a 2D image 418 and generates resized tiled images 512. Trained featurizer 520 receives the same 2D image 418 and resized tiled images 512 and generates feature map 522 and tiled feature map 524, respectively. De-bias module 530 receives feature map 522 and tiled feature map 524 and generates de-biased feature map 532 and de-biased tiled feature map 534. Upsampler 540 receives de-biased feature map and generates upsampled feature map 542. Feature enhancing module 550 receives upsampled feature map 542 and de-biased tiled feature map 534 and generates enhanced feature map 552. Feature generator 415 receives 2D image 418 and generates enhanced feature map 552.

Image tiling engine 510 receives a 2D image 418 and generates resized tiled images 512. First, image tiling engine 510 divides the 2D image 418 into uniformly sized, non-overlapping tiles. Image tiling engine 510 then generates resized tiled images 512 by resizing each uniformly sized, non-overlapping tile to match the input resolution of trained featurizer 520. Each resized tiled image 512 is then passed to trained featurizer 520 to extract features.

Trained featurizer 520 receives a 2D image 418 and resized tiled images 512 from image tiling engine 510. Trained featurizer 520 can be any type of technically feasible machine learning model. For example, in various embodiments, trained featurizer 520 can be a vision foundation model with any suitable architecture. More generally, the input data set to trained featurizer 520 can include any technically feasible data that can be processed by a transformer-based model for computer vision. Trained featurizer 520 can include multiple layers, including an attention layer, a multilayer perceptron (MLP) layer, a layer norm layer, a convolutional layer, a pooling layer, a softmax layer, and/or any other type of viable artificial neural network layer. and/or the like. Each layer of trained featurizer 520 has varying numbers of internal parameters including, without limitation, numbers of attention heads, key-value projection dimensions, numbers of neurons, types of activation functions, and/or the like. For each 2D image 418 input into trained featurizer 520, trained featurizer 520 outputs a feature map 522. A feature map 522 is a three-dimensional tensor (3D) with dimensions C×H×W, where C is the channel dimension dependent on the embedding size of trained featurizer 520, H is the height dimension, and W is the width dimension. A feature map 522 includes information on the features across a given image. In various embodiments, trained featurizer 520 identifies features that include distinct structures within an image, such as edges, parts of objects, and/or the like within the given image. Each resized tiled image 512 is also independently input into trained featurizer 520, and for each resized tiled image 512 trained featurizer 520 outputs a corresponding feature map. Then, trained featurizer 520 generates a tiled feature map 524 by stitching together the corresponding feature map for each resized tiled image 512. Trained featurizer 520 then passes feature map 522 and tiled feature map 524 to be-bias module 530.

De-bias module 530 receives feature map 522 and tiled feature map 524 from trained featurizer 520. De-bias module 530 removes noisy artifacts which may be present in feature map 522 and tiled feature map 524. Noisy artifacts are produced by trained featurizer 520 and may limit the interpretability of the features and disrupt semantic coherence. De-bias module 530 removes the noisy artifacts from the outputs of trained featurizer 520 by factoring the outputs of training featurizer 520 and adding a learnable buffer according to equation (2):

$$ViT ( x ) = f ( x ) + g ( {E}_{pos} ) + h ( x , {E}_{pos} ) \qquad ( 2 )$$

where ViT(x) is the output of trained featurizer 520 for an input x, f(x) is an artifact free semantic term that depends on the input x, g(Eₚₒₛ) is an artifact term related to spatial positions independent of the input, h(x, Eₚₒₛ) is a residual term that describes the relationship between semantics and positions g(Eₚₒₛ) is a data-independent buffer term learned during training to counteract the bias produced by ViT(x). De-bias module 530 removes the noisy artifacts in feature map 522 and tiled feature map 524 using equation (2) to generate de-biased feature map 532 and de-biased tiled feature map 534.

Upsampler 540 receives de-noised feature map 532 from de-bias module 530. Upsampler 540 improves the resolution of de-noised feature map 532 to generate upsampled feature map 542. Upsampler 540 can use any technically feasible upsampling technique to improve the resolution of de-noised feature map 532. In various embodiments, upsampler 540 uses traditional upsampling techniques, such as bilinear or bicubic upsampling, parametric upsampling techniques, such as deconvolution and resize-convolution, or pixel-adaptive upsampling techniques, such as Content-aware reassembly of features (CARAFE) or FeatUp. Upsampler 540 passes upsampled feature map 542 to feature enhancing module 550.

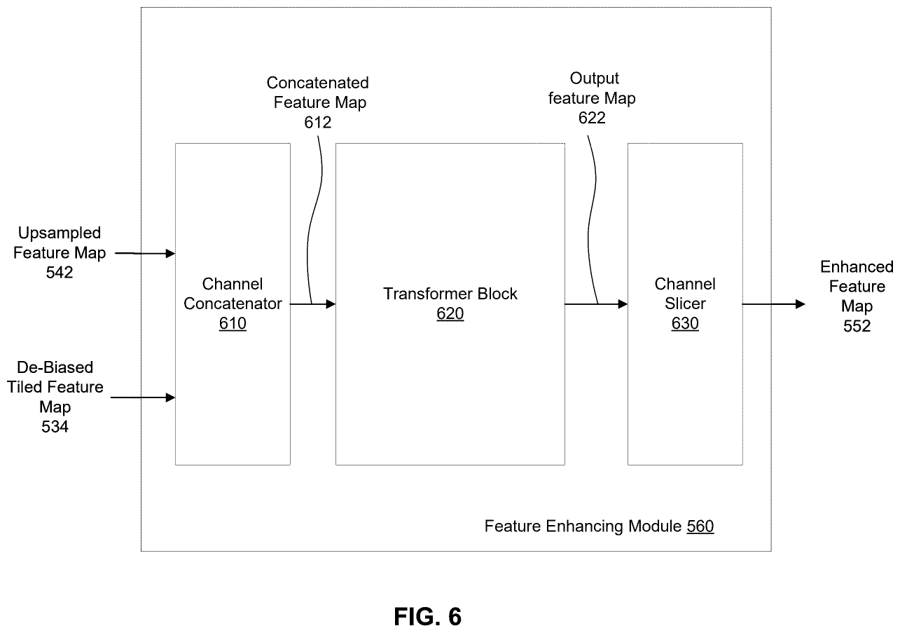

Feature enhancing module 550 receives upsampled feature map 542 and de-biased tiled feature map 534. Feature enhancing module is a transformer-based machine learning model that uses upsampled feature map 542 and de-biased tiled feature map 534 to generate enhanced feature map 552. Enhanced feature map 552 is a feature map of 2D image 418 of higher resolution than upsampled feature map 542. The operations of feature enhancing module 550 are described in conjunction with FIG. 6.

FIG. 6 is a more detailed illustration of feature enhancing module 550 of FIG. 5, according to various embodiments. As shown, feature enhancing module 550 includes, without limitation, a channel concatenator 610, a transformer block 620, and a channel slicer 630. As noted above, feature enhancing module 550 receives upsampled feature map 542 and de-biased tiled feature map 534 and generates enhanced feature map 552.

Channel concatenator 610 receives upsampled feature map 542 and de-biased tiled feature map 534. Channel concatenator 610 concatenates upsampled feature map 542 and de-biased tiled feature map 534 along the channel dimension to generate concatenated feature map 612. Given an upsampled feature map 542 with dimension C₁×H×W, where C₁ is the channel dimension, H is the height dimension, and W is the width dimension, and a de-biased tiled feature map 534 with dimension C₂×H×W where C₂ is the channel dimension, H is the height dimension, and W is the width dimension, channel concatenator 610 generates concatenated feature map 612 by stacking upsampled feature map 542 and de-biased tiled feature map 534 so that the channel dimension of concatenated feature map 612 is the sum of the channel dimensions of upsampled feature map 542 and de-biased tiled feature map 534. As a result, concatenated feature map 612 has dimension C₁+C₂×H×W. Channel concatenator 610 then passes the concatenated feature map 612 to transformer block 620.

Transformer block 620 receives concatenated feature map 612. Transformer block 620 includes a single attention layer followed by a multi-layer perceptron (MLP). In various embodiments, the attention layer of transformer block 620 is a sliding window attention layer. The MLP of transformer block 620 includes multiple artificial neural network layers. Each layer of the MLP of transformer block 620 can include a fully connected layer, a softmax layer, and/or any other type of viable artificial neural network layer. Each layer of MLP of transformer block 620 has a varying number of internal parameters including, without limitation, numbers of neurons, types of activation function, and/or the like. In various embodiments, the MLP uses a gated linear unit using the Swish function (SwiGLU) as activation function. Passing concatenated feature map 612 through the attention layer and the MLP of transformer block 620 refines the features of concatenated feature map 612 and reconstructs detailed upsampled features with multi-view consistency to generate output feature map 622. The computational cost of transformer block 620 with sliding window attention is linear in the number of input tokens to the attention layer. Transformer block 620 passes output feature map 622 to channel slicer 630.

Channel slicer 630 receives output feature map 622 from transformer block 620. Channel slicer 630 generates enhanced feature map 552 by slicing off the first C₁ channel dimensions of output feature map 622. The first C₁ channel dimensions of output feature map 622 correspond to the channel dimension of the upsampled feature map 542 because of the residual pathway of the attention layer of transformer block 620. Enhanced feature map 552 is a more detailed feature map of the 2D image 418 capable of capturing details too small for the original resolution.

### Generating Enhanced Feature Maps

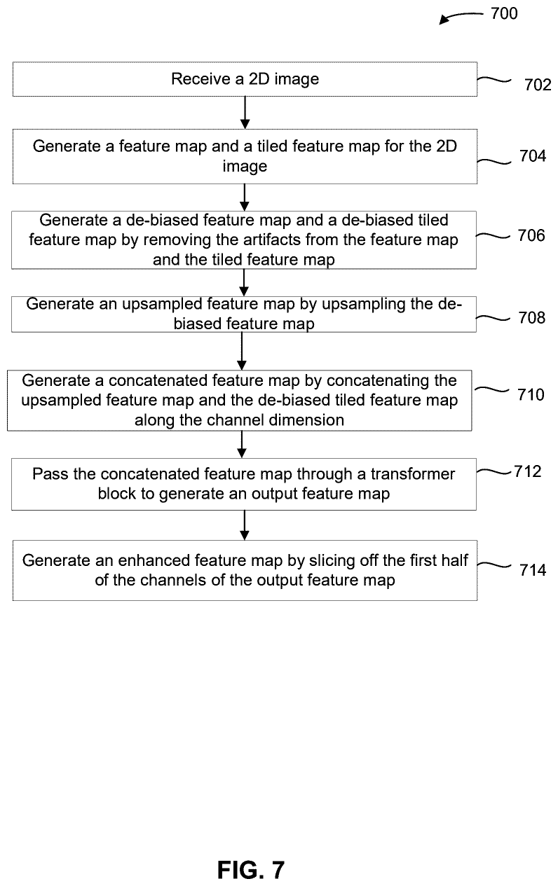

FIG. 7 is a flow diagram of method steps for generating an enhanced feature map according to various embodiments. Although the method steps are described in conjunction with the systems of FIG. 1-6, persons skilled in the art will understand that any system configured to perform the method steps, in any order, falls within the scope of the various embodiments.

As shown, a method 700 begins at step 702, where feature generator 415 receives a 2D image 418. A 2D image 418 is an image that can be obtained by any type of technically feasible video capture device, including, without limitation, a monocular camera such as a smartphone camera or a camera located in a vehicle.

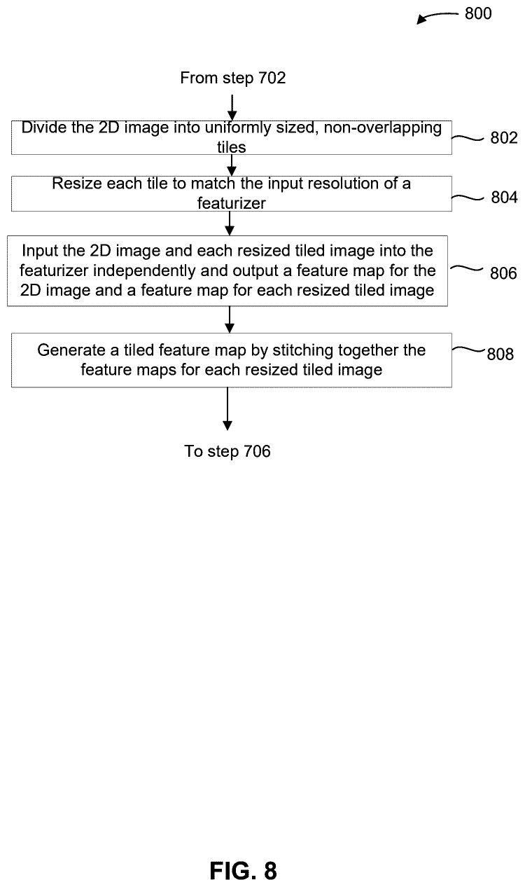

At step 704, trained featurizer 520 generates a feature map 522 and a tiled feature map 524 for the 2D image 418. Trained featurizer 520 can be any type of technically feasible machine learning model, including, for example, a vision foundation model with any suitable architecture. The steps taken by trained featurizer 520 to generate feature map 522 and tiled feature map 524 are described in further detail in conjunction with FIG. 8.

At step 706, de-bias module 530 generates de-biased feature map 532 and de-biased tiled feature map 534 by removing the artifacts from the feature map and the tiled feature map. Artifacts are produced by trained featurizer 520 and may limit the interpretability of the features and disrupt semantic coherence. More specifically, de-bias module 530 removes the noisy artifacts from the outputs of trained featurizer 520 by factoring the outputs of trained featurizer 520 and adding a learnable buffer according to equation (2).

At step 708, upsampler 540 generates an upsampled feature map 542 by upsampling the de-biased feature map 532. More specifically, upsampler 540 improves the resolution of de-noised feature map 532 to generate upsampled feature map 542. Upsampler 540 can use any technically feasible upsampling technique to improve the resolution of de-noised feature map 532. In various embodiments, upsampler 540 uses traditional upsampling techniques, such as bilinear or bicubic upsampling, parametric upsampling techniques, such as deconvolution and resize-convolution, or pixel-adaptive upsampling techniques, such as CARAFE or FeatUp.

At step 710, channel concatenator 610 generates a concatenated feature map 612 by concatenating the upsampled feature map 542 and the de-biased tiled feature map 534. Channel concatenator 610 generates concatenated feature map 612 by concatenating upsampled feature map 542 and de-biased tiled feature map 534 along the channel dimension by stacking upsampled feature map 542 and de-biased tiled feature map 534 so that the channel dimension of concatenated feature map 612 is the sum of the channel dimensions of upsampled feature map 542 and de-biased tiled feature map 534.

At step 712, feature enhancing module 560 passes the concatenated feature map 612 through a transformer block 620 to generate an output feature map 622. Transformer block 620 includes a single attention layer followed by a multi-layer perceptron (MLP). Passing concatenated feature map 612 through the attention layer and the MLP of transformer block 620 refines the features of concatenated feature map 612 and reconstructs detailed upsampled features with multi-view consistency to generate output feature map 622.

At step 714, channel slicer 630 generates an enhanced feature map 552 by slicing off the first half of the channels of the output feature map. Channel slicer 630 generates enhanced feature map 552 by slicing off the first C₁ channel dimensions of output feature map 622. The first C₁ channel dimensions of output feature map 622 correspond to the channel dimension of the upsampled feature map 542 because of the residual pathway of the attention layer of transformer block 620.

FIG. 8 is a flow diagram of method steps for generating feature maps and tiled feature maps, according to various embodiments. Although the method steps are described in conjunction with the systems of FIGS. 1-6, persons skilled in the art will understand that any system configured to perform the method steps, in any order, falls within the scope of the various embodiments.

As shown, a method 800 begins at step 802, where image tiling engine 510 divides the 2D image 418 into uniformly sized, non-overlapping tiles. More specifically, from step 702 of FIG. 7, the 2D image is received by image tiling engine 510 and image tiling engine 510 divides the 2D image 418 into uniformly sized, non-overlapping tiles.

At step 804, image tiling engine 510 resizes each tile to match the input resolution of trained featurizer 520. More specifically, image tiling engine 510 generates resized tiled images 512 by resizing each uniformly sized, non-overlapping tile to match the input resolution of trained featurizer 520.

At step 806, feature generator 415 inputs the 2D image 418 and each resized tiled image 512 into the trained featurizer 520 independently and outputs a feature map for the 2D image 418 and a feature map for each resized tiled image 512. For the 2D image 418 input into trained featurizer 520, trained featurizer 520 outputs a feature map 522. Each resized tiled image 512 is input into the trained featurizer 520 independently and for each resized tiled image 512 trained featurizer 520 outputs a corresponding feature map.

At step 808, trained featurizer 520 generates a tiled feature map 524 by stitching together the feature maps for each resized tiled image 512. More specifically, trained featurizer 520 stitches together the feature maps for each resized tiled image 512 to generate a tiled feature map 524.

### Using Enhanced Feature Maps

FIG. 9 is a flow diagram of method steps for using enhanced feature maps, according to various embodiments. Although the method steps are described in conjunction with the systems of FIGS. 1-6, persons skilled in the art will understand that any system configured to perform the method steps, in any order, falls within the scope of the various embodiments.

As shown, a method 900 begins at step 902, where an application 445 receives a 2D image 418. A 2D image 418 is an image that can be obtained by any type of technically feasible video capture device, including, without limitation, a monocular camera such as a smartphone camera or a camera located in a vehicle. Application 445 can be, without limitation, any type of image segmentation system, or object detection system in an autonomous or manned vehicle and/or a hand-held device.

At step 904, application 445 generates an enhanced feature map 552. More specifically, application 445 accesses feature generator 415 from data store 420 and feature generator 415 generates enhanced feature map 552 using method 700.

At step 906, application 445 uses the enhanced feature map 552 to segment objects from the 2D image 418. In various embodiments, 445 can use a camera in an autonomous vehicle and feature generator 415 to identify pedestrians, other vehicles, or annotate an image to displays landmarks or other points of interest.

In sum, a higher resolution feature map of an input image is generated by passing an upsampled feature map and a tiled feature map generated by a vision foundation model through a transformer. First, an image is input into a vision foundation model and the vision foundation model outputs a feature map. Next, the same image is divided into tiles. Each tile is resized to match the input resolution of the vision foundation model and input into the vision foundation model independently. The vision foundation model outputs a feature map for each resized tile and the feature maps for each resized tile are then stitched back together to produce a tiled feature map. The feature map and the tiled feature map are de-biased to remove artifacts of the vision foundation model. Then, an upsampling technique is applied to the de-biased feature map to produce an upsampled feature map. The de-biased tiled feature map and the upsampled feature map are then passed through a transformer block with sliding window attention and the transformer block outputs an enhanced feature map of higher resolution than the tiled feature map and the upsampled feature map.

At least one technical advantage of the disclosed techniques relative to the prior art is that, with the disclosed techniques higher resolution feature maps of 2D images are produced. The disclosed techniques generate feature maps that more accurately capture small objects and fine-grained details of the input image than prior art approaches, thereby increasing the usefulness of feature maps in downstream prediction tasks. In addition, the disclosed techniques remove artifacts in the feature maps generated by a vision foundation model. Another technical advantage is that the computational cost of generating higher resolution feature maps with the disclosed techniques is less than the computational cost of running a vision foundation model at higher resolution. The computational cost of generating a higher resolution feature map using the disclosed techniques increases linearly with respect to the number of tokens, whereas the computational cost of generating a higher resolution feature map using a vision transformer increases quadratically. These technical advantages represent one or more technological improvements over prior art approaches.

Aspects of the subject matter described herein are set out in the following numbered clauses.
1. In some embodiments, a computer-implemented method for generating an enhanced feature map comprises receiving a two-dimensional (2D) image, processing the 2D image to generate a feature map and a tiled feature map, generating a de-biased feature map and a de-biased tiled feature map by removing artifacts from the feature map and the tiled feature map, generating an upsampled feature map from the de-biased feature map, generating a concatenated feature map from the upsampled feature map and the de-biased tiled feature map, processing the concatenated feature map to generate an output feature map, and generating an enhanced feature map by slicing off one or more channels of the output feature map.
2. The computer-implemented method of clause 1, wherein processing the 2D image to generate the feature map and the tiled feature map comprises using a trained vision foundation model.
3. The computer-implemented method of clauses 1 or 2, wherein the enhanced feature map has higher resolution than the feature map generated by the trained vision foundation model.
4. The computer-implemented method of any of clauses 1-3, wherein generating the tiled feature map comprises dividing the 2D image into a plurality of tiles, resizing each tile in the plurality of tiles to match an input resolution of the trained vision foundation model to generate a plurality of resized tiles, using the trained vision foundation model to generate a respective feature map for each resized tile in the plurality of resized tiles, and generating the tiled feature map by stitching together the respective feature map of each resized tile in the plurality of resized tiles.
5. The computer-implemented method of any of clauses 1-4, wherein the plurality of tiles are uniformly sized and non-overlapping.
6. The computer-implemented method of any of clauses 1-5, wherein generating the de-biased feature map and the de-biased tiled feature map comprises factoring the feature map and the tiled feature map and adding a learnable buffer.
7. The computer-implemented method of any of clauses 1-6, wherein generating the concatenated feature map comprises concatenating the upsampled feature map and the de-biased tiled feature map along a channel dimension.
8. The computer-implemented method of any of clauses 1-7, wherein a size of the channel dimension of the upsampled feature map and the de-biased feature map is determined by an embedding size of a vision foundation model.
9. The computer-implemented method of any of clauses 1-8, wherein generating the output feature map comprises processing the concatenated feature map using a transformer block.
10. The computer-implemented method of any of clauses 1-9, wherein the transformer block comprises an attention layer and a multi-layer perceptron.
11. The computer-implemented method of any of clauses 1-10, wherein the transformer block is trained using a multi-view consistency loss function.
12. The computer-implemented method of any of clauses 1-11, wherein the concatenated feature map comprises a plurality of channels, and the one or more channels are half of the plurality of channels.
13. In some embodiments, one or more non-transitory computer-readable media store instructions that, when executed by at least one processor, cause the at least one processor to perform the steps of receiving a 2D image, processing the 2D image to generate a feature map and a tiled feature map, generating a de-biased feature map and a de-biased tiled feature map by removing artifacts from the feature map and the tiled feature map, generating an upsampled feature map from the de-biased feature map, generating a concatenated feature map from the upsampled feature map and the de-biased tiled feature map, processing the concatenated feature map to generate an output feature map, and generating an enhanced feature map by slicing off one or more channels of the output feature map.
14. The one or more non-transitory computer-readable media of clause 13, wherein processing the 2D image to generate the feature map and the tiled feature map comprises using a trained vision foundation model.
15. The one or more non-transitory computer-readable media of clauses 13 or 14, wherein generating the tiled feature map comprises dividing the 2D image into a plurality of tiles, resizing each tile in the plurality of tiles to match an input resolution of the trained vision foundation model to generate a plurality of resized tiles, using the trained vision foundation model to generate a respective feature map for each resized tile in the plurality of resized tiles, and generating the tiled feature map by stitching together the respective feature map of each resized tile in the plurality of resized tiles.
16. The one or more non-transitory computer-readable media of any of clauses 13-15, wherein the plurality of tiles are uniformly sized and non-overlapping.
17. The one or more non-transitory computer-readable media of any of clauses 13-16, wherein generating the de-biased feature map and the de-biased tiled feature map comprises factoring the feature map and the tiled feature map and adding a learnable buffer.
18. The one or more non-transitory computer-readable media of any of clauses 13-17, wherein generating the concatenated feature map comprises concatenating the upsampled feature map and the de-biased tiled feature map along a channel dimension.
19. The one or more non-transitory computer-readable media of any of clauses 13-18, wherein generating the output feature map comprises processing the concatenated feature map using a transformer block.
20. In some embodiments, a system comprises one or more memories storing instructions, and one or more processors that are coupled to the one or more memories and, when executing the instructions, are configured to perform steps comprising receiving a 2D image, processing the 2D image to generate a feature map and a tiled feature map, generating a de-biased feature map and a de-biased tiled feature map by removing artifacts from the feature map and the tiled feature map, generating an upsampled feature map from the de-biased feature map, generating a concatenated feature map from the upsampled feature map and the de-biased tiled feature map, processing the concatenated feature map to generate an output feature map, and generating an enhanced feature map by slicing off one or more channels of the output feature map.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating an enhanced feature map, the method comprising:
receiving a two-dimensional (2D) image;
processing the 2D image to generate a feature map and a tiled feature map;
generating a de-biased feature map and a de-biased tiled feature map by removing artifacts from the feature map and the tiled feature map;
generating an upsampled feature map from the de-biased feature map;
generating a concatenated feature map from the upsampled feature map and the de-biased tiled feature map;
processing the concatenated feature map to generate an output feature map; and
generating an enhanced feature map by slicing off one or more channels of the output feature map.

2. The computer-implemented method of claim 1, wherein processing the 2D image to generate the feature map and the tiled feature map comprises using a trained vision foundation model.

3. The computer-implemented method of claim 2, wherein the enhanced feature map has higher resolution than the feature map generated by the trained vision foundation model.

4. The computer-implemented method of claim 2, wherein generating the tiled feature map comprises:
dividing the 2D image into a plurality of tiles;
resizing each tile in the plurality of tiles to match an input resolution of the trained vision foundation model to generate a plurality of resized tiles;
using the trained vision foundation model to generate a respective feature map for each resized tile in the plurality of resized tiles; and
generating the tiled feature map by stitching together the respective feature map of each resized tile in the plurality of resized tiles.

5. The computer-implemented method of claim 4, wherein the plurality of tiles are uniformly sized and non-overlapping.

6. The computer-implemented method of claim 1, wherein generating the de-biased feature map and the de-biased tiled feature map comprises factoring the feature map and the tiled feature map and adding a learnable buffer.

7. The computer-implemented method of claim 1, wherein generating the concatenated feature map comprises concatenating the upsampled feature map and the de-biased tiled feature map along a channel dimension.

8. The computer-implemented method of claim 7, wherein a size of the channel dimension of the upsampled feature map and the de-biased feature map is determined by an embedding size of a vision foundation model.

9. The computer-implemented method of claim 1, wherein generating the output feature map comprises processing the concatenated feature map using a transformer block.

10. The computer-implemented method of claim 9, wherein the transformer block comprises an attention layer and a multi-layer perceptron.

11. The computer-implemented method of claim 9, wherein the transformer block is trained using a multi-view consistency loss function.

12. The computer-implemented method of claim 1, wherein:
the concatenated feature map comprises a plurality of channels; and
the one or more channels are half of the plurality of channels.

13. One or more non-transitory computer-readable media storing instructions that, when executed by at least one processor, cause the at least one processor to perform the steps of:
receiving a 2D image;
processing the 2D image to generate a feature map and a tiled feature map;
generating a de-biased feature map and a de-biased tiled feature map by removing artifacts from the feature map and the tiled feature map;
generating an upsampled feature map from the de-biased feature map;
generating a concatenated feature map from the upsampled feature map and the de-biased tiled feature map;
processing the concatenated feature map to generate an output feature map; and
generating an enhanced feature map by slicing off one or more channels of the output feature map.

14. The one or more non-transitory computer-readable media of claim 13, wherein processing the 2D image to generate the feature map and the tiled feature map comprises using a trained vision foundation model.

15. The one or more non-transitory computer-readable media of claim 14, wherein generating the tiled feature map comprises:
dividing the 2D image into a plurality of tiles;
resizing each tile in the plurality of tiles to match an input resolution of the trained vision foundation model to generate a plurality of resized tiles;
using the trained vision foundation model to generate a respective feature map for each resized tile in the plurality of resized tiles; and
generating the tiled feature map by stitching together the respective feature map of each resized tile in the plurality of resized tiles.

16. The one or more non-transitory computer-readable media of claim 15, wherein the plurality of tiles are uniformly sized and non-overlapping.

17. The one or more non-transitory computer-readable media of claim 13, wherein generating the de-biased feature map and the de-biased tiled feature map comprises factoring the feature map and the tiled feature map and adding a learnable buffer.

18. The one or more non-transitory computer-readable media of claim 13, wherein generating the concatenated feature map comprises concatenating the upsampled feature map and the de-biased tiled feature map along a channel dimension.

19. The one or more non-transitory computer-readable media of claim 13, wherein generating the output feature map comprises processing the concatenated feature map using a transformer block.

20. A system, comprising:
one or more memories storing instructions; and
one or more processors that are coupled to the one or more memories and, when executing the instructions, are configured to perform steps comprising:
receiving a 2D image;
processing the 2D image to generate a feature map and a tiled feature map;
generating a de-biased feature map and a de-biased tiled feature map by removing artifacts from the feature map and the tiled feature map;
generating an upsampled feature map from the de-biased feature map;
generating a concatenated feature map from the upsampled feature map and the de-biased tiled feature map;
processing the concatenated feature map to generate an output feature map; and
generating an enhanced feature map by slicing off one or more channels of the output feature map.
